(19) United States
(12) Patent Application Publication
(10) Pub. No.: US 2024/0308166 A1
(43) Pub. Date: Sep. 19, 2024

(54) APPARATUS AND PROCESS FOR EXTRACTING OIL FROM PLANT MATERIAL

(71) Applicant: I.B.E GREEN POINT RESEARCH AND DEVELOPMENT LTD, Beer Sheva (IL)

(72) Inventors: Ben LEIBUSHER, Omer (IL); Elena Yarden KING, Beer Sheva (IL); Amir HORVITZ, Merhavim (IL); Orgad BARSADE, Ramat Gan (IL); Raphael MOISA, Omer (IL)

(21) Appl. No.: 18/270,278

(22) PCT Filed: Jan. 6, 2022
(86) PCT No.: PCT/IL2022/050023

§ 371 Date: Jun. 29, 2023

(30) Foreign Application Priority Data
Jan. 7, 2021 (IL) 280022

(51) Int. Cl. B30B 9/04; B30B 15/06; B30B 15/34; C11B 1/08

(52) U.S. Cl. CPC B30B 9/047; B30B 15/06; B30B 15/34; C11B 1/08

(57) ABSTRACT

Apparatus for forming a cake of compressed plant material, comprising a bottom die having a cylindrical upper portion, an inverted conical lower portion and a post extending vertically upwardly from a small-diameter region of the lower portion, wherein plant material is introducible into a cavity of the bottom die surrounding the post; a top die designed and configured to conform to the cylindrical upper portion and the post and having an inverted conical lower portion with a narrower diameter than a corresponding portion in the bottom die; a power train operable to drive the top die into the bottom die so as to be in pressing relation with the plant material interposed between the top and bottom dies for a sufficient duration to produce a cake of compressed plant material.

### FIELD OF THE INVENTION

The invention is in the field of plant processing. More particularly, the invention is related to an apparatus and process for extracting oil from plant material.

### BACKGROUND OF THE INVENTION

The extraction of oil from plant material, such as cannabis, for the purpose of producing a medicinal product is known to have been performed through chemical means, such as with the use of solvents, but involves high expenditure and results in a costly product.

For purposes of this specification and the accompanying claims, the term “cannabis” includes Cannabis sativa, cannabis indica and Cannabis ruderalis as well as hybrids thereof.

Medical cannabis is a cannabis and/or cannabis product containing cannabinoids prescribed by physicians for patients.

Uses of medical cannabis include, but are not limited to, reduction of nausea and vomiting during chemotherapy, improvement of appetite, chronic pain management, control of muscle spasms, and epilepsy treatment.

Oil has been extracted with the use of a rosin press, whereby plant material inserted between two heated plates is pressed, causing liquid rosin to be extracted. However, the extracted liquid rosin is viscous and is issued in many different directions, adhering to various surfaces and made difficult to collect.

It is an object of the present invention to provide effective apparatus for extracting oil from plant material by mechanical means.

It is another object of the present invention to provide an apparatus and process by which oil extracted from plant material is ensured to be directed to a single port and be easily collected.

Other objects and advantages of the invention will become apparent as the description proceeds.

### SUMMARY OF THE INVENTION

Apparatus for forming a cake of compressed plant material, comprising:
(a) a bottom die having a cylindrical upper portion, an inverted conical lower portion and a post extending vertically upwardly from a small-diameter region of the lower portion, wherein plant material is introducible into a cavity of the bottom die surrounding the post;
(b) a top die designed and configured to conform to the cylindrical upper portion and the post and having an inverted conical lower portion with a narrower diameter than a corresponding portion in the bottom die; and
(c) a power train operable to drive the top die into the bottom die so as to be in pressing relation with the plant material interposed between the top and bottom dies for a sufficient duration to produce a cake of compressed plant material.

The apparatus may further comprise guide rails aligning the top die with the bottom die, one or more connectors attaching the top die to the guide rails and a base attaching the bottom die to the guide rails.

An article of manufacture comprising:
a) a round member made of compressed and coalesced plant material having a circumferential portion and a central hole; and
b) a reinforceable capsule made of deformable material which is configured with an inner surface and an outer surface to define a cavity therebetween within which the round member is receivable, such that the inner and outer surfaces collectively embrace the circumferential portion of the round member while remaining unattached at a lower region thereof to facilitate discharge of oil extractable from the plant material across the lower region.

The round member may have a shape of a truncated cone.

The inner and outer surfaces may be configured as truncated cones having each an upper large-diameter region and a lower small-diameter region, such that the inner truncated cone of the capsule is seated in the outer truncated cone to form the cavity within which the round member is receivable.

The inner and outer cones of the capsule may be each configured with an annular lip extending radially outwardly from the upper large-diameter region and arranged such that the lip of the inner cone is engaged with the lip of the outer cone.

The article of manufacture may further comprise a removable seal covering a space between apical ends of the truncated cones and may be provided in an external wrapper.

Apparatus for extracting oil from plant material, comprising:
(a) a capsule comprising a compressed cake of plant material;
(b) a lower die sized and configured to hold the capsule;
(c) an upper die; and
(d) a power train configured to drive the upper die into the lower die so as to be in pressing relation with the capsule between the upper and lower dies for a sufficient duration to cause deformation of the capsule and to apply sufficient force onto the plant material that initiates oil extraction, wherein the extracted oil is discharged to a single discharge port.

The apparatus may further comprise a heating element in the upper die or in the lower die, or in both the upper die and lower die and a control unit for controllably activating at least one of the heating elements.

The capsule may be configured with a closed cavity within which the cake of plant material is retained with the exception of a single unattached capsule region through which the extracted oil is discharged to the single discharge port.

The capsule may be releasably held by a retractable drawer.

The power train may be synchronized to cause the lower die to push the capsule upwardly before the capsule is pressed by the upper die.

The apparatus may further comprise reinforcing apparatus for sufficiently reinforcing at least a portion of the capsule when being deformed to prevent rupturing of the capsule.

The apparatus may further comprise an oil collection vessel positioned below the single discharge port and below the single unattached capsule region. The oil collection vessel may be releasably supported by a retractable drawer.

An oil extracting process, comprising the steps of producing a cake of compressed plant material configured with a central hole, securing the cake within a capsule, pressing the capsule until oil is extracted from the plant material outwardly to the central hole and is discharged to a single discharge port. The process may further comprise the steps of collecting the extracted oil in a vessel and automatically diluting the collected oil with a diluent. The process may further comprise the step of automatically mixing the extracted oil and the diluent.

One aspect of some embodiments of the invention relates to a ring of compressed cannabis plant material which holds its shape. According to various exemplary embodiments of the invention the ring includes 2, 4, 6, 8, 10 or intermediate or greater numbers of grams of cannabis plant material.

Another aspect of some embodiments of the invention relates to a press designed and configured to prepare a ring of compressed cannabis plant material.

Still another aspect of some embodiments of the invention relates to a sealed pod containing a ring of compressed cannabis plant material. In some embodiments the pod is constructed of aluminum. In some exemplary embodiments of the invention, the pod includes two nested cups, circumferentially sealed about their top edges. In some embodiments the cups are in the shape of truncated cones.

Yet another aspect of some embodiments of the invention relates to an extraction apparatus designed and configured to receive a sealed pod and exert sufficient pressure on the pod to collapse it, and the ring of cannabis plant material contained therein, so that oil is expelled from the plant material. In some embodiments one or more portions of the apparatus that contact the pod are heated. In some embodiments heat contributes to a reduction in viscosity of the oil. In some embodiments, a reduction in viscosity of the oil contributes to an increase in yield.

It will be appreciated that the various aspects described above relate to solution of technical problems associated with breakdown of active ingredients in cannabis oil between point of production and point of use.

Alternatively or additionally, it will be appreciated that the various aspects described above relate to solution of technical problems related to reducing the health hazards associated with smoking of medical cannabis.

In some exemplary embodiments of the invention there is provided an apparatus including: (a) a bottom die having a cylindrical upper portion, an inverted conical lower portion and a post extending vertically therein; (b) a top die designed and configured to conform to the cylindrical upper portion and the post and having a an inverted conical lower portion with a narrower diameter than a corresponding portion in the bottom die; and (c) a power train operable to push the top die into the bottom die. In some embodiments the apparatus includes guide rails aligning the top die with the bottom die. Alternatively or additionally, in some embodiments, the apparatus includes one or more connectors for fixating the top die. Alternatively or additionally, in some embodiments the apparatus includes a base attaching the bottom die to the guide rails. Alternatively or additionally, in some embodiments the power train provides a force of up to 5,000 N. Alternatively or additionally, in some embodiments a difference in radius of the inverted conical portion of the lower die and the inverted conical portion of the upper die is 3.5 mm to 7 mm.

In some exemplary embodiments of the invention there is provided an article of manufacture including a ring of compressed cannabis plant material characterized by a thickness of 3.5 mm to 7 mm. In some embodiments the ring has the shape of a truncated cone. Alternatively or additionally, in some embodiments the truncated cone has a height of at least 2 cm to 7 cm for 10 gr of pressed cannabis plant material.

In some exemplary embodiments of the invention there is provided an article of manufacture including: (a) an inner truncated cone of deformable material seated in a larger outer truncated cone to form a cavity between the truncated cones; (b) a ring of compressed cannabis plant material occupying the cavity; and (c) a circumferential seal joining the bases of the truncated cones. In some embodiments the article of manufacture includes a removable seal covering a space between apical ends of the truncated cones. Alternatively or additionally, in some embodiments the article of manufacture is provided in an external wrapper. Alternatively or additionally, in some embodiments the ring of compressed cannabis plant material comprises at least 2 grams of plant material. Alternatively or additionally, in some embodiments the cavity has a thickness of 3.5 mm to 7 mm.

In some exemplary embodiments of the invention there is provided an apparatus comprising: (a) a receptacle sized and configured to hold a pod containing a compressed ring of cannabis plant material; (b) a piston; and (c) a power train configured to cause the piston to move into the receptacle and move an inner truncated cone of the pod with respect to an outer truncated cone of the pod. In some embodiments the power train provides a force of up to 5,000 N. Alternatively or additionally, in some embodiments the apparatus includes a heating element in the piston. Alternatively or additionally, in some embodiments the apparatus includes a heating element in the receptacle. Alternatively or additionally, in some embodiments the apparatus includes an oil collection vessel positioned below the receptacle.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) are W/W (weight per weight) unless otherwise indicated.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is simplified flow diagram of a process according to some exemplary embodiments of the invention;

FIG. 2A is a transverse cross section of an apparatus according to some exemplary embodiments of the invention in a first operational state;

FIG. 2B is a transverse cross section of the apparatus from FIG. 2A in a second operational state;

FIG. 3—illustrates a “cake” or a ring, made of compressed plant material, such as inflorescence;

FIG. 4A is a top perspective view of an inner truncated cone according to some exemplary embodiments of the invention;

FIG. 4B is a transverse cross section of the inner truncated cone of FIG. 4A;

FIG. 4C is a top perspective view of an outer truncated cone according to some exemplary embodiments of the invention;

FIG. 4D is a transverse cross section of the outer truncated cone of FIG. 4C;

FIG. 4E is a top perspective view of an article of manufacture according to some exemplary embodiments of the invention;

FIG. 4F is a top perspective view of is a transverse cross section of the article of manufacture of FIG. 4E;

FIG. 5 is a transverse cross section of an apparatus according to some exemplary embodiments of the invention;

FIG. 6A is a transverse cross section of a portion of an article of manufacture as in FIG. 3E prior to pressing;

FIG. 6B is an enlarged transverse cross section as in FIG. 6A before pressing;

FIG. 6C is a transverse cross section in perspective view, as in FIG. 6A after pressing;

FIG. 6D is an enlarged transverse cross section of FIG. 6C after pressing;

FIG. 7 illustrates the extraction apparatus with a dilution system, a mixing system and a control system, housed within the casing of a compact and user friendly device;

FIG. 8 illustrates the extraction apparatus when the casing is removed, when the drawers are in a retracted position;

FIG. 9 illustrates the extraction apparatus of FIG. 7, when most of the casing is rendered transparent and the casing drawers are set to an extended position;

FIG. 10A illustrates a capsule when it is set in an initial lower position in the drawer;

FIG. 10B illustrates a capsule set in an upwardly pressed position;

FIGS. 11A and 11B illustrate the designed holding position of the oil collection vessel;

FIG. 12 shows the lower die assembly with an inverted U-shaped frame that defines a central cavity, through which the oil collection vessel drawer passes;

FIG. 13 is a perspective view of the lower die and the and the oil collection vessel holder;

FIG. 14 is a cross-sectional view of the lower die, the oil collection vessel holder and the mixing vibrator;

FIGS. 15A-D illustrate the extraction apparatus, while upper die is gradually displaced closer to lower die in conjunction with power train, while the inner cone of the capsule becomes deformed;

FIG. 16 is a cross-sectional view of the dilution system;

FIG. 17 is a cross-sectional view of the mixing vibrator; and

FIG. 18 shows the extraction apparatus, configured with reinforcing apparatus for reinforcing at least a portion of capsule when being deformed.

### DETAILED DESCRIPTION OF THE INVENTION

Embodiments of the invention relate to apparatus and articles of manufacture.

Specifically, some embodiments of the invention can be used to prepare plant material such as cannabis for extraction of oil and/or to extract oil from the prepared plant material.

The principles and operation of an apparatus and/or articles of manufacture according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being used or carried out in various ways. Also, it is to be understood that the phraseology and terminology employed herein is for the purpose of description and should not be regarded as limiting.

### Process Overview

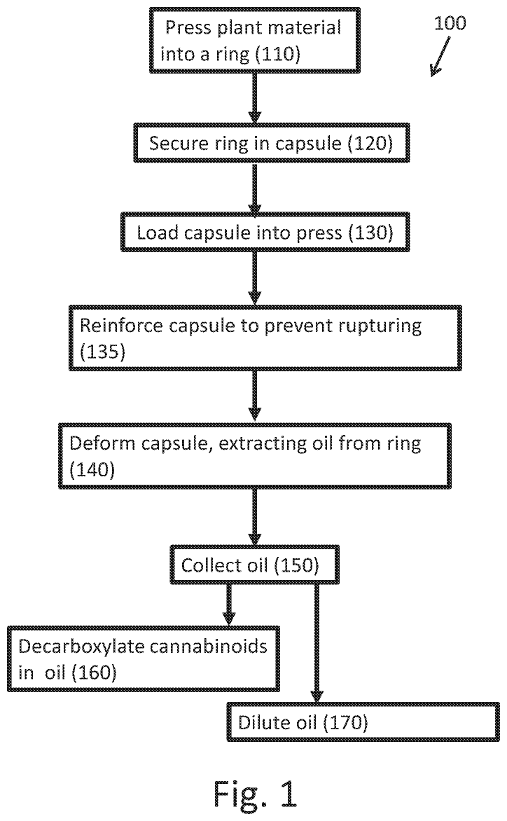

FIG. 1 is a simplified flow diagram of a process, indicated generally as 100, for extracting oil from plant material. It is stressed that many exemplary embodiments of the invention do not include all of the steps in process 100.

In FIG. 1, process 100 begins with pressing 110 plant material into a “cake” in the form of a round member such as a ring with a central hole. By using the term “cake” it is meant to include any symmetrical solid 3-D object, which is formed by compressed plant material, such as inflorescence. In some embodiments the round member has the form of a truncated cone. The cake is an article of manufacture according to some exemplary embodiments of the invention. Alternatively or additionally, an apparatus used to form the cake is an embodiment of the invention.

The formed cake is then secured 120 in a capsule. The capsule is an article of manufacture according to some exemplary embodiments of the invention, and an apparatus for sealing the capsule, such as in a single direction, constitutes an additional embodiment of the invention.

According to various embodiments of the invention the capsules are used immediately or stored for varying amounts of time. In some embodiments if capsules are stored, they are individually wrapped to preserve freshness of the cake of plant material secured inside.

The capsule is then loaded 130 into a press. Within the interior of the press, the capsule is reinforced 135, at least partially, to prevent rupturing and is then deformed 140. Deformation 140 extracts oil containing the desired chemical constituents, e.g. the cannabinoid constituent derived from cannabis, from the cake of plant material. In some embodiments deformation 140 includes heating. In some embodiments heating contributes to a reduction in oil viscosity and/or an increase in yield.

The oil is collected 150 at a single outlet of the press. In some embodiments collection is passive and involves positioning a collection vessel below the capsule loaded in the press at 130.

In some embodiments of the invention, cannabinoids in the oil are decarboxylated 160. Decarboxylation includes controlled application of heat. In some embodiments the press which holds the capsule is equipped with a heating element positioned to heat the collection vessel in a controlled manner for decarboxylation.

In some embodiments of the invention, the oil is diluted 170. According to various embodiments of the invention dilution 170 is with food oil and/or an alcohol (e.g. ethanol) and/or water. In some embodiments vitamins and/or other nutrients are added to the diluent. In some embodiments dilution 170 is done using a reservoir (e.g. of food oil), from which the diluent is drafted (e.g., by pumping or by gravitation). In some embodiments the press is equipped with a button or switch that transfers a measured portion of diluent into the collection vessel. In some embodiments, the oil is diluted with any liquid suitable for use with cannabis oil, including but not limited to terpenes, alcohol, and vitamins.

### Cake Forming Apparatus

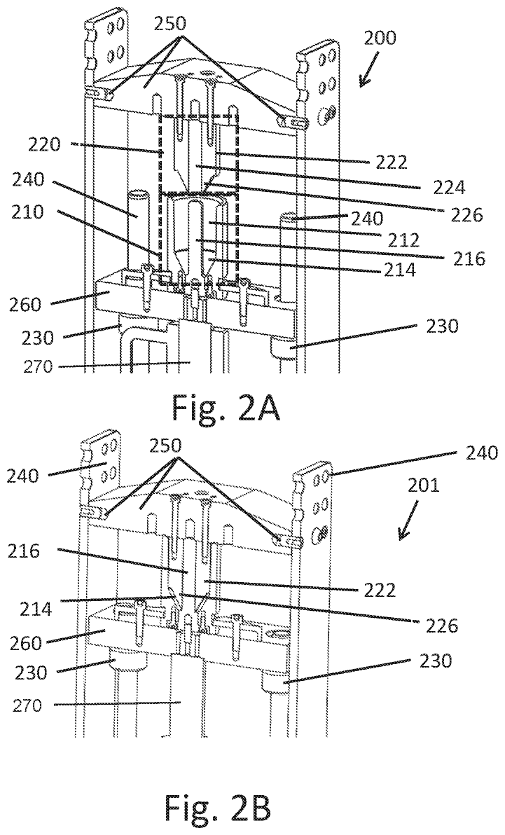

FIG. 2A is a vertical cross section in perspective view of an apparatus, according to some embodiments of the invention in a first operational state, indicated generally as 200.

FIG. 2B is a vertical cross section in perspective view of the apparatus of FIG. 2A in a second operational state, indicated generally as 201. Operation of the apparatus includes loading it with desired amount of plant material, which may be measured, in operational state 200. Subsequent transition to operational state 200 compresses the plant material to form a cake in the form of a ring. In many embodiments of the invention, the ring has the form of a hollow truncated cone. This procedure corresponds generally to 110 in FIG. 1.

In the depicted embodiment of FIG. 2A and FIG. 2B, the apparatus includes a bottom die 210 having a cylindrical upper portion 212, an inverted conical lower portion 214 and a post 216 extending vertically upwardly from the small-diameter region of conical portion 214.

The depicted apparatus includes a top die 220 designed to conform to the cylindrical upper portion of the bottom die 222 and is configured with a cylindrical cavity 224 to accommodate the post of the bottom die. Top die 220 includes an inverted conical lower portion 226 with a slightly narrower diameter than the corresponding portion 214 in the bottom die.

The depicted apparatus includes a piston 270 operable to push said top die into said bottom die. In the depicted embodiment, piston 270 raises bottom die 210, but the net effect is still that the top die is sufficiently pushed into the bottom die so as to be in pressing relation with the plant material interposed between the top and bottom dies. To facilitate easy removal of the cake after being pressed and to prevent adhesion of the cake to the top and bottom dies, an article undetached to the cake forming apparatus, such as a plastic article, e.g. nylon, conforming to the shape and size of the bottom die is positioned in abutting relation with the bottom die before the plant material to be pressed is loaded. In other embodiments of the invention, the powertrain moves top die 220 downwards into bottom die 210.

In the depicted embodiment, the apparatus includes a rigid frame 240, for holding and aligning top die 220 with bottom die 210.

In the depicted embodiment, the apparatus includes one or more connectors 250 attaching top die 220 to rigid frame 240.

In the depicted embodiment, the apparatus includes a base 260, which slides over the guiding rails 230.

In some embodiments of the invention, piston 270 provides a force ranging from 5,000-60,000 N or intermediate or greater forces, and is configured to apply this pressing force for a duration of at least 20 seconds and at room temperature in order to suitably form the cake. Alternatively or additionally, in some embodiments a difference in radius of said inverted conical portion 214 of lower die 210 and inverted conical portion 226 of upper die 220 ranges from 2-15 mm or intermediate or greater distances. In some embodiments the distance is 3.5 mm to 7 mm, optionally about 5 mm.

Operation of the depicted apparatus produces a cake of compressed plant material which is an article of manufacture comprising for example 3-15 gr, or intermediate or greater amounts, of plant material according to some embodiments of the invention. In some embodiments of the invention, the cake member of compressed plant material is characterized by a thickness of 3.5 mm to 7 mm, optionally about 5 mm or greater.

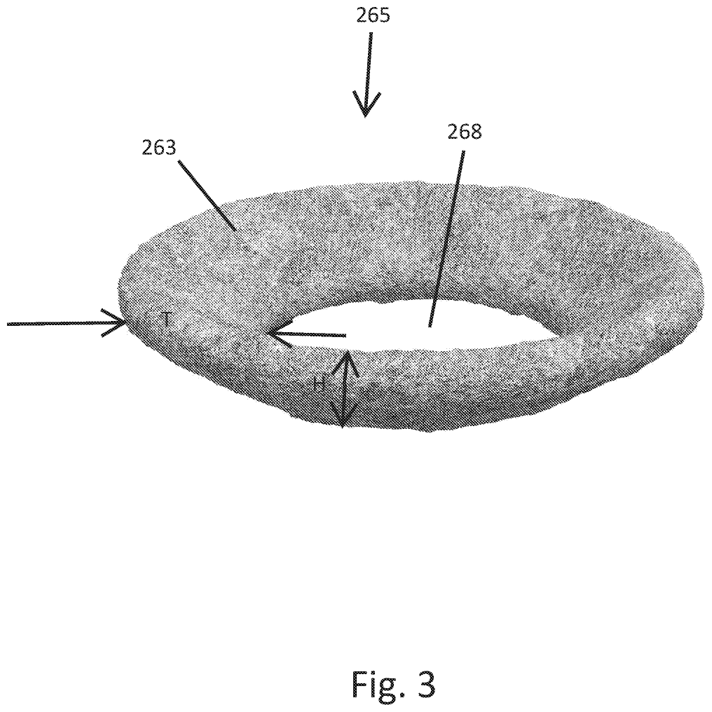

A cake 265, or a round member made of compressed plant material, such as inflorescence, is illustrated in FIG. 3. Cake 265 of substantial structural strength is formed with a circumferential portion 263 in response to the cooperation of the top and bottom dies and with a central hole 268 corresponding to the diameter of the post of the bottom die. The coalescence of cake 265 is made possible by the natural compaction of the plant matter that is often agglutinated by virtue of the adhesivity of the plant matter and by the pressing force transmitted by the power train. If needed, an agglutinating agent may be added. The thickness T of cake 265 is dependent upon the amount of plant matter that has been loaded into the cake forming apparatus.

In some embodiments the cake has the shape of a truncated cone. In some embodiments the truncated cone has a height H of 2-7 cm for 10 gr of compressed plant material.

### Capsule

The annular cake 265 of compressed plant material described hereinabove is generally fragile. In order to protect it during manipulation and storage, some embodiments of the invention include securing the cake in a deformable capsule (see 120 in FIG. 1). In some embodiments of the invention, the deformable capsule prevents the extracted oil from coming into contact with the apparatus. A capsule containing a cake of compressed plant material is another embodiment of the invention.

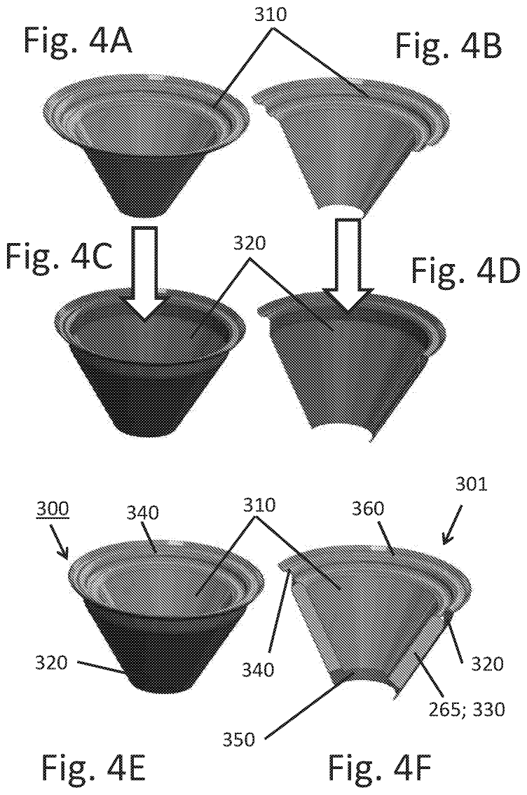

FIG. 4A is a top perspective view of an inner truncated cone 310, according to some embodiments of the invention.

FIG. 4B is a vertical cross section in perspective view of the inner truncated cone of FIG. 4A.

FIG. 4C is a top perspective view of an outer truncated cone 320, according to some embodiments of the invention.

FIG. 4D is a vertical cross section in perspective view of the outer truncated cone of FIG. 4C.

FIG. 4E is a top perspective view of an article of manufacture, indicated generally as 300, according to some embodiments of the invention. As indicated by the vertical arrows from 4A to 4C and 4B to 4D, capsule 300 is produced upon inserting an inner cone 310 into an outer cone 320 containing an annular cake of compressed plant material.

FIG. 4F is a vertical cross section in perspective view, indicated generally as 301 of the article of manufacture of FIG. 4E.

In the depicted embodiment, article of manufacture 300 is a capsule including an inner truncated cone 310 of deformable material, such as aluminum, seated in a larger outer truncated cone 320 to form a cavity 330 between the two truncated cones. In the depicted embodiment, annular cake of compressed plant material 265 is placed in outer cone 320 so that it occupies cavity 330. Truncated cones 310 and 320 may be joined at their large-diameter annular lip 360 by a circumferential seal 340. In other embodiments, the circumferential seal may be disposed of as lip 360 of inner cone 310 becomes deformed to seal the upper region of capsule 300, as will be described hereinafter. Although capsule 300 is sealed at its upper region and unsealed at its lower apical region, cake 265 remains in contact with, and secured to, the capsule and does not slide downwardly therefrom as a result of the larger diameter of outer cone 320 relative to the lower region of the conical cake 265 such that the cake is wedged to the outer cone.

Depicted article of manufacture 300 includes a space 350 between apical ends of truncated cones 310 and 320. In some embodiments a removable seal covers space 350. Alternatively or additionally, in some embodiments capsule 300 is provided with an external wrapper.

In some embodiments of the invention, truncated cones 310 and 320 each independently have an apex angle of 15°-175° or intermediate or greater angles. Alternatively or additionally, in some embodiments, truncated cones 310 and 320 each independently have a radius at their lip of 10-100 mm or intermediate or greater radii.

According to various embodiments of the invention, cake 265 of compressed plant material includes 3-15 grams or intermediate or larger numbers of grams of plant material.

In some embodiments of the invention, cavity 330 has a thickness of 3.5 mm to 7 mm, optionally about 5 mm.

Inner and outer truncated cones 310 and 320 can be manufactured in different ways and ways are discussed here without precluding implementation of other manufacturing methods.

In some embodiments cones 310 and/or 320 are produced by stamping.

In some embodiments cones 310 and/or 320 are produced by vacuum molding.

In some embodiments cones 310 and/or 320 are produced by injection molding.

In some embodiments cones 310 and/or 320 are produced by cutting semicircles from a sheet of material, cutting a semicircular notch in the middle of a straight edge of the semicircle, and joining the two resultant straight edges to form a seam.

In some embodiments of the invention, a combination of methods is used. For example, cutting semicircles from a sheet of material, cutting a semicircular notch in the middle of a straight edge of the semicircle, and joining the two resultant straight edges to form a seam is followed by stamp pressing to form a circumferential edge that can be sealed.

In some embodiments of the invention, cones 310 and/or 320 are constructed of aluminum. In some embodiments of the invention, the aluminum has a thickness of 0.3 mm to 0.6 mm, optionally about 0.4 mm.

In other embodiments of the invention, cones 310 and/or 320 are constructed of any material with strength which can withstand a pressure of at least 60 bar, with good biocompatibility to plant material such as cannabis plant material, ductility and heat transfer similar to the property of Aluminum 8011 in thickness of 0.3 to 0.6 mm.

### Extraction Apparatus

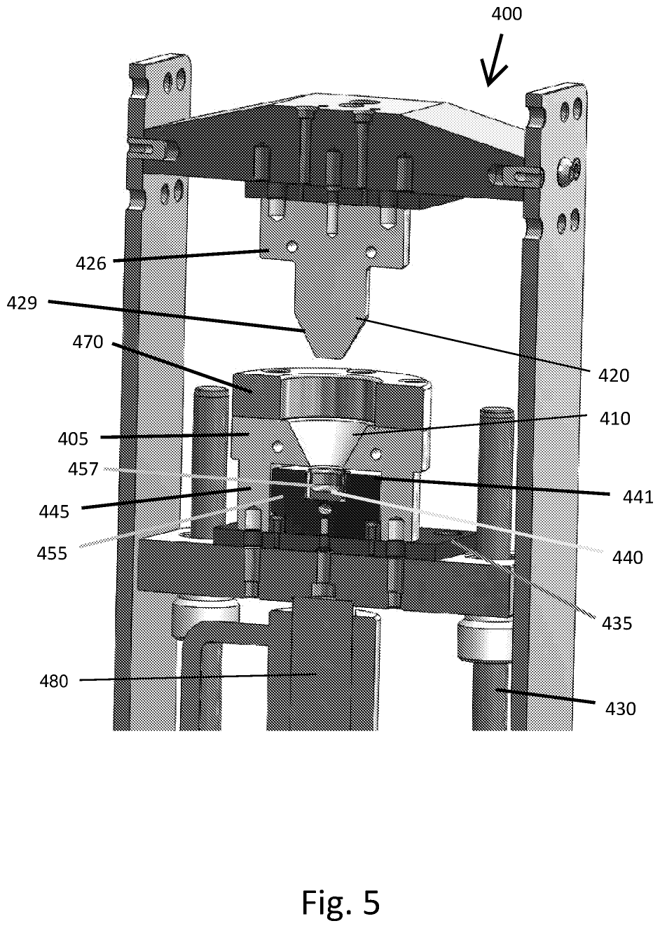

FIG. 5 is a vertical cross section in perspective view of an extraction apparatus, indicated generally as 400, according to some embodiments of the invention. The depicted apparatus receives a capsule as described hereinabove, and presses it to extract oil (see 130, 140 and 150 in FIG. 1).

Extraction apparatus 400 comprises an annular bottom die 405 configured with a through-hole cavity 410, e.g. truncated and inverted cone shaped, which is sized and shaped to hold a capsule 300 (FIG. 4E) containing a cake of plant material. Extending downwardly from and integrally with bottom die 405 is an annular connection portion 445 for connection to plate 435. Plate 435 in turn is in drivable engagement with a power train 480. Positioned within the internal cavity 441 of connection portion 445, which is of a significantly larger width or diameter than that of cavity 410 at the bottom face of bottom die 405, is a collection vessel holder 455 which is also connected to plate 435. Collection vessel holder 455 has a cavity 457 that is recessed from its upper surface and aligned with through-hole cavity 410, so that the illustrated oil collection vessel 440 when positioned within cavity 457 is assured of received all the oil that has been extracted from the capsule. The size of oil collection vessel 440 and of cavity 457 is set to be sufficiently small so that the amount of oil that adheres to the walls of oil collection vessel 440 will be minimized. Collection vessel holder 455 is also configured with a horizontal groove (not shown) aligned with cavity 457, through which collection vessel 440 is able to be removed after a sufficient amount of oil has been collected. Oil collection vessel 440 may be conveniently configured with a handle for assistance in manipulation thereof.

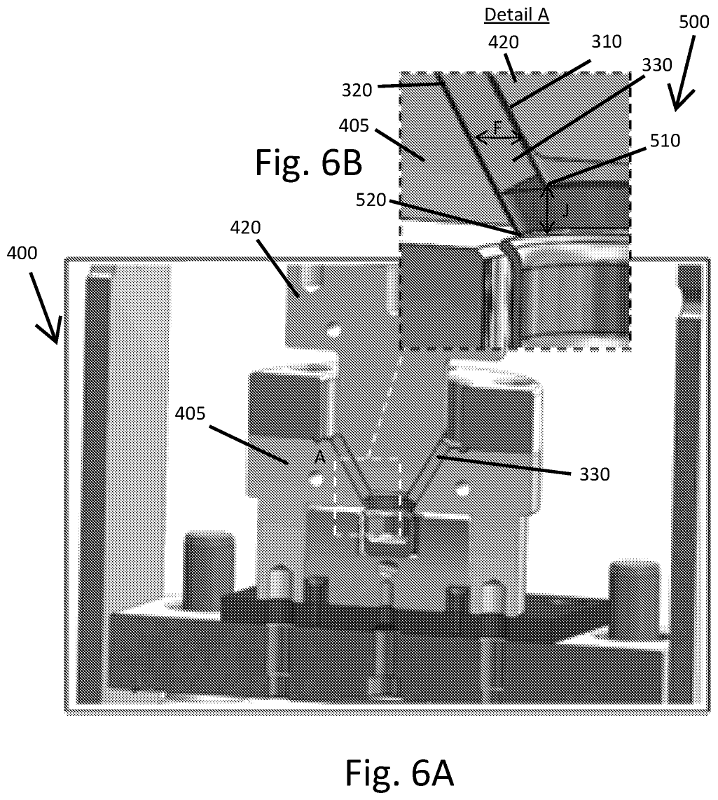

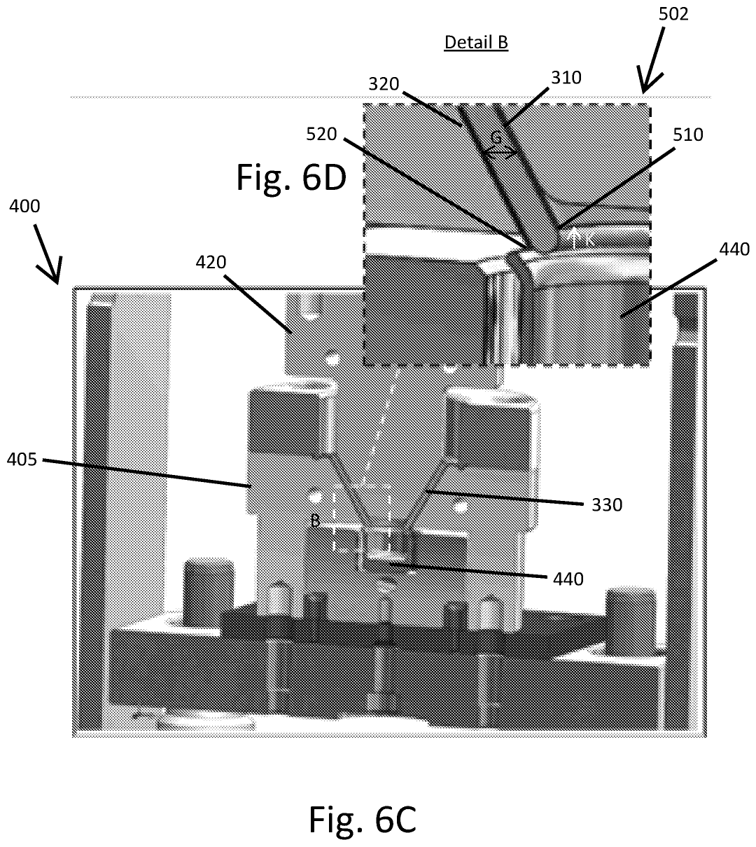

Depicted apparatus 400 also comprises an upper die 420 and a power train 480 (e.g., a piston), configured to cause upper die 420 to be drivingly introduced into cavity 410 and deform the inner truncated cone of the capsule. The process of capsule deformation is described in greater detail hereinbelow in the context of FIGS. 6A-D.

In some embodiments of the invention, power train 430 is suitable to provide a force of 5,000-50,000 N or intermediate or greater forces.

Power train 480 is operable to drive upper die 420 into through-hole cavity 410. In the depicted embodiment, power train 480 raises lower die 405, but the net effect is still that upper die 420 is driven into lower die 405. In other embodiments of the invention, the power train 480 drives upper die 420 downwardly into lower die 410.

A limiting ring 470 may be connected to the upper surface of lower die 405. Ring 470 is adapted to contact shoulder 426 of upper die 420 and to thereby limit the depth of penetration of conical portion 429 of upper die 420 into cavity 410. Shoulder 426 is positioned radially outwardly to conical portion 429. A limiting ring 470 of a different thickness may be used depending on the size of the cake provided with the capsule. In some embodiments of the invention, ring 470 is used to secure the lip of the capsule to prevent it from sliding from its position as a result of the mechanical forces it is subjected to.

In some embodiments of the invention, apparatus 400 includes a heating element in upper die 420. Alternatively or additionally, in some embodiments apparatus 400 includes a heating element in cavity 410. In some embodiments of the invention, the heating elements contribute to a reduction in oil viscosity and/or an increase in yield.

FIG. 6A is a vertical cross section in perspective view, indicated generally as 500, of extraction apparatus 400 and a portion of an article of manufacture as in FIG. 4E prior to pressing.

FIG. 6C is a vertical cross section in perspective view, indicated generally as 502, as in FIG. 6A after pressing.

FIGS. 6B and 6D are enlargements of FIGS. 6A and 6C.

FIGS. 6A-D are presented to show what happens to a capsule (300 in FIG. 4E) when upper die 420 is introduced into a cavity 410 (FIG. 5) within which is seated the capsule.

When upper die 420 is introduced into cavity 410 (FIG. 5), as shown in FIGS. 6A-B, it occupies the entire interior of, and therefore exerts pressure on, inner cone 310. This pressure causes inner cone 310 to move downwards while outer cone 320 is held in place by lower die 405, as shown in FIGS. 6C-D. Relative motion of inner cone 310 with respect to outer cone 320 causes deformation of circumferential seal 340 (see FIG. 4E), if applied, and decreases the volume of cavity 330, which is located between inner cone and outer cone 320.

As a result, the horizontal distance between inner cone 310 and outer cone 320 is greater prior to pressing than after pressing (compare arrow F in FIG. 6B to arrow G in FIG. 6D). Alternatively or additionally, the vertical distance between a lower edge 510 of inner cone 310 and a lower edge 520 of outer cone 320 is greater prior to pressing than after pressing (compare arrow J in FIG. 6B to arrow K in FIG. 6D). The increased force exerted by upper die 420 on the cake received in cavity 330 due to the reduction in volume of cavity 330 causes oil to be expelled from the plant material provided in the cake. This expelled oil is directed through cavity 330 by virtue of the annular configuration of the cake, and is assured of dripping from lower edge 510 of inner cone 310 and/or lower edge 520 of outer cone 320 into oil collection vessel 440 by virtue of the conical configuration of cones 310 and 320 and upper die 420. If any of the oil is expelled upwardly, it will be deflected downwardly by the upper seal formed during the deformation of inner cone and outer cone 320.

According to various embodiments of the invention, the yield of oil from the plant material in cavity 330 is typically 5-30%. The cannabinoid content of the extracted oil is typically between 45% to 99.9% or intermediate or lower percentages.

FIGS. 7-17 illustrate another embodiment of an extraction apparatus, indicated generally as 600.

In this embodiment, extraction apparatus 600, as well as a dilution system, a mixing system and a control system, which will be described hereinafter, are all housed within the casing of a compact and user friendly device 620, which is illustrated in FIG. 7. Device 620 is configured with two vertically spaced and slidably extendable drawers 640 and 650, which are used to conveniently load and remove the capsule and oil collection vessel, respectively, and are preferably made of lightweight and inexpensive material, such as plastic.

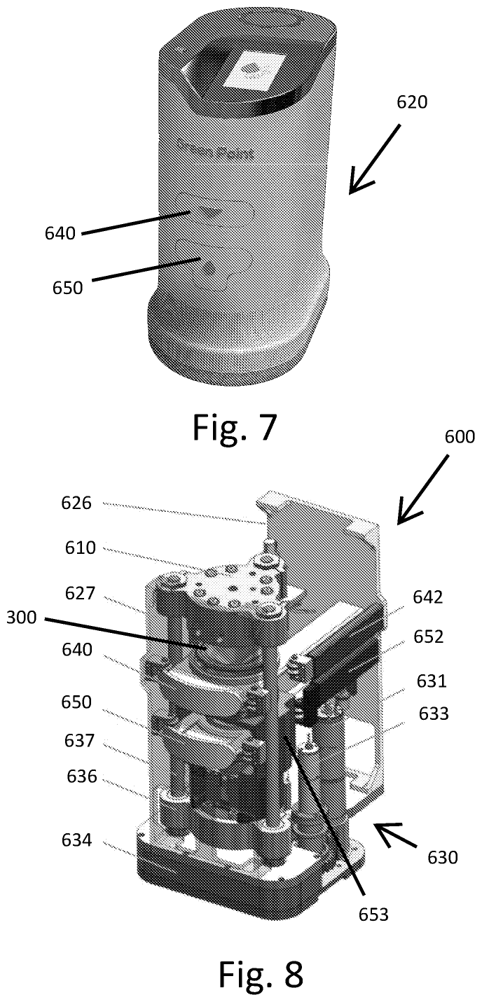

FIG. 8 illustrates extraction apparatus 600 when the casing is removed, with the exception of back panel 626 and side panel 627, and when drawers 640 and 650 are in a retracted position.

In this embodiment, power train 630 drives both the upper die extending downwardly from upper plate 610 in a downward direction and the lower die extending upwardly from bottom base 636 in an upward direction to urge the introduction of the upper die into the interior of capsule 300 and to perform a pressing operation, as described hereinabove. Power train 630 comprises main gear motor 631, clutch gear motor 633, main gear system 634, bottom base 636, and a plurality of rods 637 that are threadedly engaged with plate 610 and base 636. Each end of a rod may be threaded in a different rotational direction to produce the simultaneous vertical displacement of the upper and lower dies in opposite directions. Operation of power train 630 causes rotation of rods 637 as well known to those skilled in the art and therefore vertical displacement of base 636 and of lower die assembly 653 attached thereto.

Any power train described herein may employ any available energy source or mechanism which provides the required force. Exemplary mechanisms include, but are not limited to hydraulic, pneumatic, or electric pistons. Exemplary power sources include, but are not limited to, electricity and manual power.

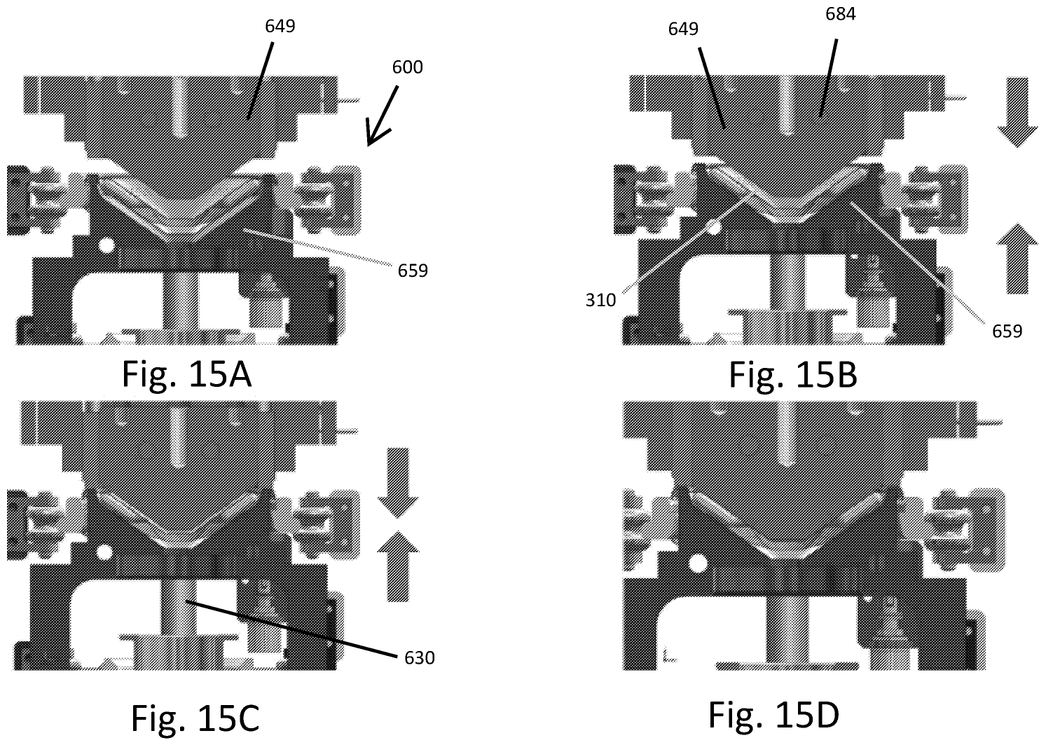

As shown in FIGS. 15A-D, extraction apparatus 600 functions similarly to extraction apparatus 400 of FIG. 5, while upper die 649 is gradually displaced closer to lower die 659 in conjunction with power train 630 while inner cone 310 of the capsule becomes deformed to facilitate efficient oil extraction.

Capsule 300 is held within a ring provided in drawer 640, and the oil collection vessel is held within an opening formed in drawer 650. Both drawers 640 and 650 are slidably and extendably connected to rails, 642 and 652, respectively, which are attached to back panel 626.

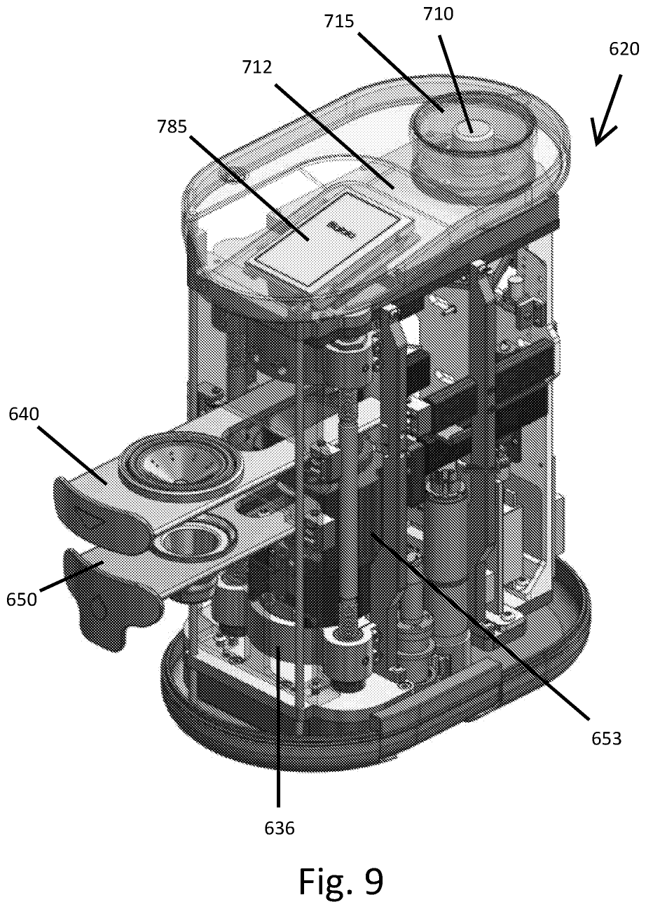

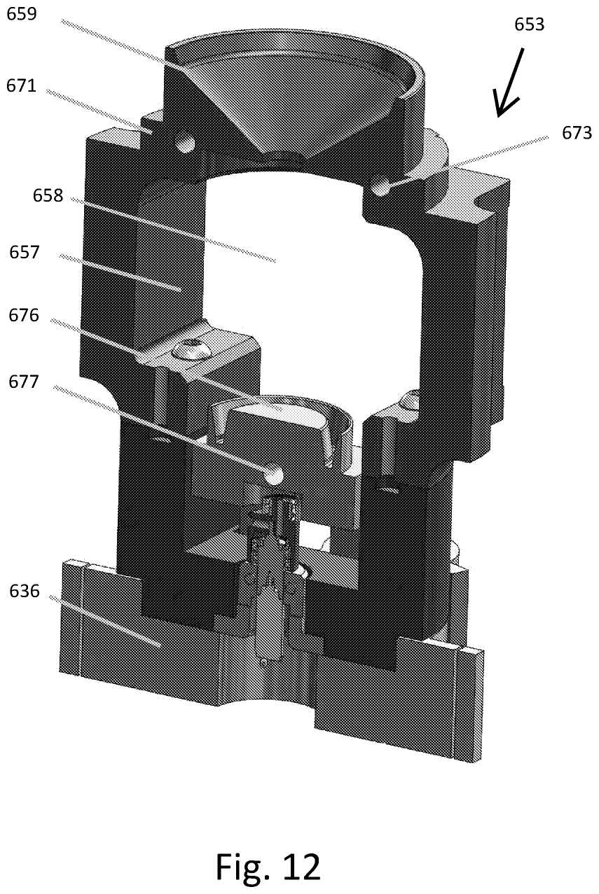

FIG. 9 illustrates device 620, when most of the casing is rendered transparent and the casing drawers 640 and 650 are set to an extended position. Lower die assembly 653, which is attached to, and extends upwardly from, base 636, advantageously does not interfere with collection vessel holding drawer 650 while being vertical displaced in order to interface with capsule 300 during a pressing operation by virtue of being configured with an inverted U-shaped frame 657 that defines a central cavity 658 shown in FIG. 12 through which drawer 650 passes. The vertical dimension of cavity 658 is greater than the intended vertical displacement of lower die assembly 653. Conical lower die 659 protrudes upwardly from frame 657.

Even though capsule holding drawer 640 is made of a lightweight material, it is advantageously not damaged during a pressing operation since lower die 659, by suitable synchronization of the power train, is configured to contact and push upwardly capsule 300 before the upper die is introduced into the interior of the capsule. As a result of being slightly displaced upwardly from drawer 640, the pressing force applied by the upper and lower dies will not appreciably, if at all, be transmitted to drawer 640.

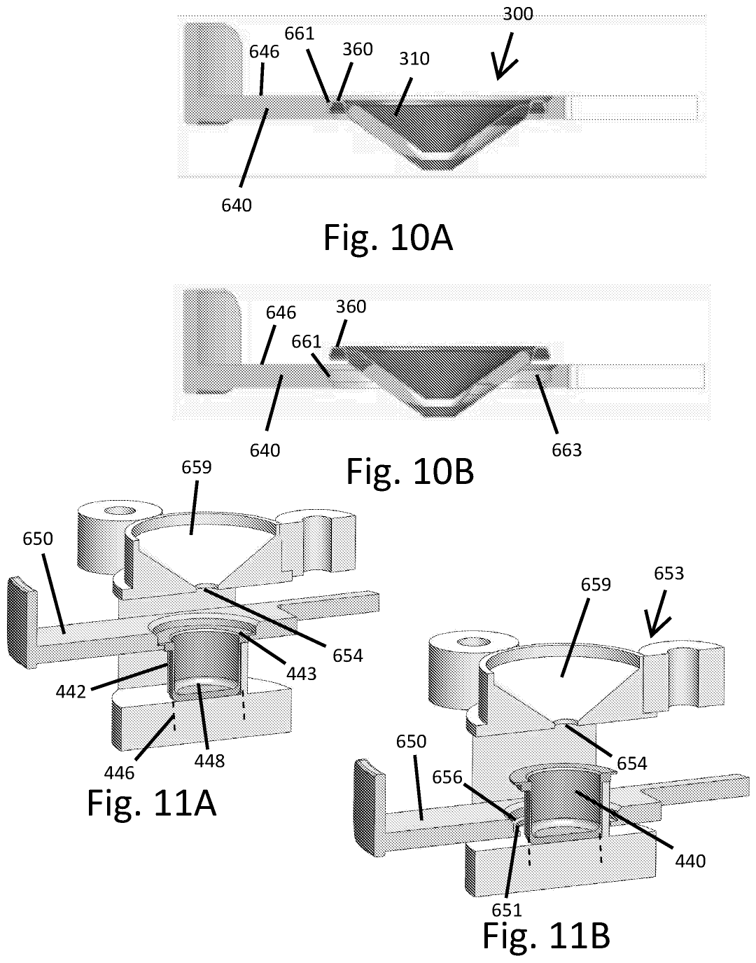

FIG. 10A illustrates capsule 300 when it is set in an initial lower position in drawer 640, such that the annular large-diameter lip 360 of inner cone 310 is in abutment with the circular edge 661 of the through-hole 663 formed in drawer 640 and does not upwardly protrude from the upper drawer edge 646. FIG. 10B illustrates capsule 300 when it is set in an upper position, such that lip 360 ceases to be in contact with edge 661. The vertical displacement of lip 360 between the downwardly and upper positions is approximately a few millimeters.

As shown in FIGS. 12-14, lower die assembly 653 is configured with heating elements that ensure that the extracted oil will be sufficiently heated to facilitate oil flow into oil collection vessel 440. An annular base 671 connecting lower die 659 to frame 657 is formed with a bore 673 within which a first heating element 674 is inserted. A second heating element 678 is inserted within a bore 677 formed in a base 676 supporting the oil collection vessel 440. A third heating element may be inserted within a bore 684 formed in upper die 649, as shown in FIG. 15B.

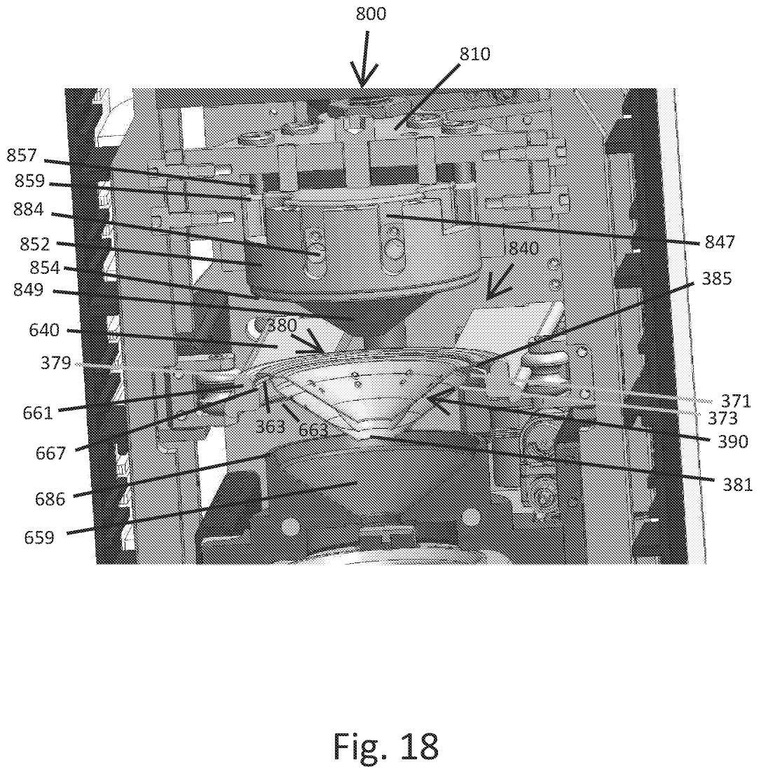

As shown in FIG. 18, the extraction apparatus, indicated generally as 800, is configured with reinforcing apparatus 840 for reinforcing at least a portion of capsule 380 when being deformed (see 135 and 140 of FIG. 1). The power train applying a relatively high-magnitude force on the order of thousands of Newtons initiates relative motion between upper die 849 and lower die 659 that causes capsule 380 to be sufficiently pressed between the upper and lower dies so that oil will be extracted from the plant material provided in the capsule. Since the plant material is retained in a closed cavity 390 within capsule 380, with the exception of the lower unattached capsule region 381, and the material from which the capsule is made of low strength, the pressure of the retained plant material will steadily increase by the pressing force until exceeding the yield strength of the capsule and cause the capsule to become ruptured, if the capsule were not satisfactorily reinforced.

In this embodiment, reinforcing apparatus 840 comprises a rim 686 of lower die 659 and an open resiliently and vertically displaceable cylindrical wall 852 having a limited height and a relatively large thickness for forcefully contacting in two opposite directions and therefore reinforcing the mutually engaged annular lips 385 of capsule 380. Wall 852 encircles the cylindrical upper portion 847 of upper die 849 while the inverted conical lower portion of the upper die protrudes downwardly from, and through the interior of, wall 852. Outer wall 852 may be configured with a plurality of cutout regions to prevent interference with the heating element insertable within bore 884 formed in upper die 849.

A plurality of circumferentially spaced, spring powered and vertically expandable rods 857, such as telescopingly expandable rods, are each fixedly connected to both stationary upper plate 810 and the upper edge 859 of outer wall 852. When the bottom edge 854 of outer wall 852 is contacted, the internal spring of each rod 857 is compressed, forcing outer wall 852 to rise.

The thickness of rim 686 of lower die 659 is substantially equal to, and slightly less than, the radial dimension of the rim-insertable interspace 363 provided at the upper lip adjoining regions of capsule 380. Rim-insertable interspace 363 is defined between a wall 371 of the outer cone that is oriented at a significantly smaller angle relative to a vertical plane than the outer cone wall 373 which is engageable with lower die 659 and which extends to wall 371, and between the mutually engaged walls 379 of the inner and outer cones that are supported by surface 667 extending radially inwardly from edge 661 of the through-hole 663 formed in drawer 640. The mutually engaged annular lips 385 of the inner and outer cones extend radially outwardly from wall 371 to wall 379.

As lower die 659 is gradually driven upwardly by the power train, rim 686 is inserted within rim-insertable interspace 363 and contacts the mutually engaged annular lips 385 of capsule 380. Since rim 686 is in contact with the mutually engaged lips 385, additional vertical displacement of lower die 659 in a second step of a reinforcement operation across through-hole 663 causes capsule 380 to be raised above drawer 640, as shown in FIG. 10B. Additional vertical displacement of lower die 659 in a third step of a reinforcement operation causes lower circular edge 853 of cylindrical wall 852 to contact the mutually engaged lips 385 from above while rim 686 contacts the mutually engaged lips 385 from below, before upper die 849 contacts the die-engageable wall 383 of the inner cone. This combined, oppositely directed contact of lips 385 by rim 686 and edge 686 ensures lip reinforcement during the subsequent capsule deformation and prevents rupturing of the lips. Additional vertical displacement of lower die 659 in a fourth step of a reinforcement operation causes cylindrical wall 852 to be displaced upwardly and upper die 849 to contact the die-engageable wall 383 of the inner cone. As cylindrical wall 852 is displaced upwardly, each spring provided internally to a corresponding rod 857 is compressed, transmitting an increased pressing and reinforcing force to the mutually engaged lips 385. Additional vertical displacement of lower die 659 in a fifth step of a reinforcement operation causes cylindrical wall 852 to be displaced even more upwardly to a maximum position that is assured of not occluding bore 884 and a corresponding increased pressing force is transmitted to the mutually engaged lips 385.

It will be appreciated that reinforcing apparatus 840 may be provided with any extraction apparatus described herein.

It will be appreciated that other embodiments of reinforcing apparatus are envisioned insofar as at least one region of the capsule, and preferably a region adjoining the cavity in which is receivable plant material, is suitably contacted while the capsule is being deformed to extract oil.

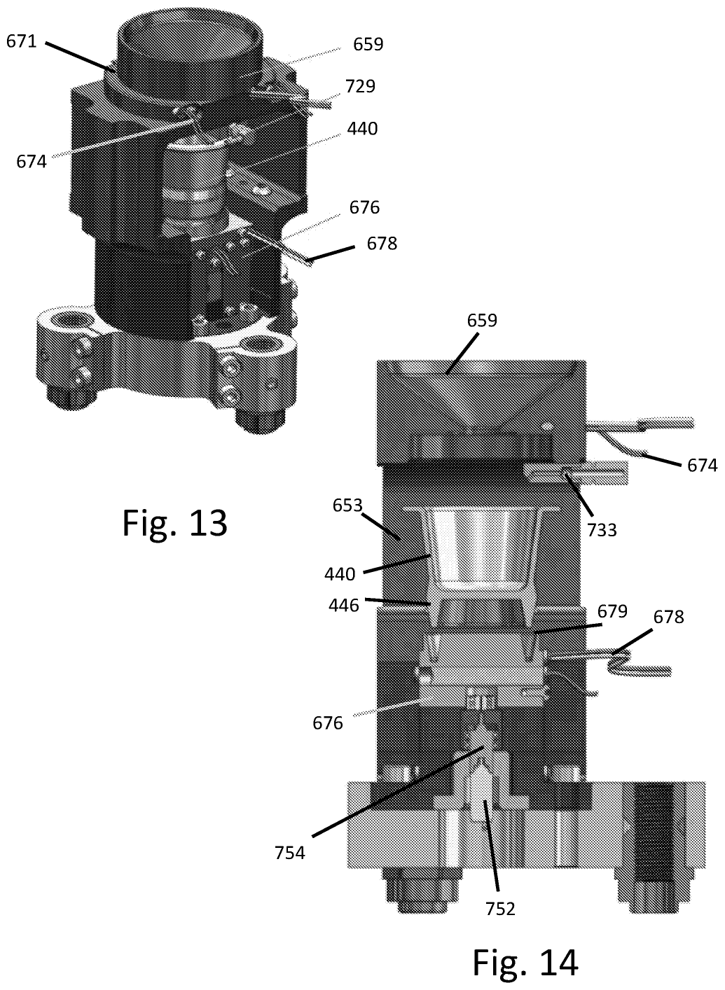

In another embodiment, the extraction apparatus is configured with a dilution system 700 for diluting the extracted oil, for example in accordance with a prescribed regimen. A vertically oriented inverted container 710 filled with a dilution solution is positioned in chamber 715, which is connected to an upper housing surface 712, as shown in FIG. 9. As shown in FIGS. 13, 14 and 16, inverted container 710 is attached to a base 725, which in turn is mounted to the casing by bracket 727. The dilution solution is gravitationally dischargeable from container 710 across a seal 726 and through a lower hose connector 729 and control valve 733 to oil collection vessel 440.

A sensor 722 is preferably employed to ensure accuracy in discharging the dilution solution, such as to confirm that container 710 has not been completely emptied. Sensor 722 may be an optical eye that is responsive to a light beam emitted by an emitter 721 positioned within container 710, which may be transparent or translucent. A sensor unit may be connected to base 725 by intervening surface 724.

A mixing system 750 shown in FIGS. 14 and 17 may be activated when the dilution solution is added to ensure homogeneity of the diluted oil. Mixing system 750 comprises a gear motor 752 that drives a vibrator 754, which in turn causes oil collection vessel holder 676 to vibrate to thoroughly mix the diluted oil received in oil collection vessel 440.

An efficacious mixing operation is contingent upon effectively transmitting the vibrating forces generated by the vibrator to the oil collection vessel.

Upward displacement of lower die assembly 653 may also be influential in causing the oil collection vessel 440 to be set in force transmitting relation with oil collection vessel holder 676, to allow the generated vibrating forces to mix the diluted extracted oil.

FIG. 14 illustrates oil collection vessel 440 when slightly separated from oil collection vessel holder 676, e.g. by a few millimeters, after lower die assembly 653 has undergone some upward displacement and a lower cylindrical wall 446 of oil collection vessel 440 remains slightly above the upper surface 679 of oil collection vessel holder 676. This position of oil collection vessel 440 (which may be referred to as the “designed holding position”) is made possible when held by the lower drawer, which for sake of clarity is not shown. However, generated vibrating forces will not be transmitted to the oil collection vessel due to this separation.

Lower die assembly 653 may be configured with oil collection vessel holder 676 that protrudes for a limited distance into cavity 658, as shown in FIG. 12, and that may serve to transfer motion to oil collection vessel 440 when lower die assembly 653 is upwardly displaced.

FIG. 11A illustrates the designed holding position of the oil collection vessel, which is shown to be configured with an upper cylindrical wall 442, an upper annular lip 443 of a larger outer diameter than the upper cylindrical wall, and a lower cylindrical wall 446 which is separated from upper cylindrical wall 442 by surface 448. As shown in FIG. 11B, drawer 650 is configured with a circular aperture 651 that is bounded by a surface 656 that is recessed from the upper surface of drawer 650. The oil collection vessel is set at the designed holding position shown in FIG. 11A when lip 443 is supported by recessed surface 656.

After oil collection vessel 440 is set at the designed holding position, upward displacement of lower die assembly 653 causes oil collection vessel holder 676 to couple with lower cylindrical wall 446. The coupling action is made possible by the configuration of oil collection vessel holder 676, which, as shown in FIG. 17, has a peripheral wall 683 that is radially separated from a protrusion 687, e.g. of semicircular cross section, enabling lower cylindrical wall 446 of oil collection vessel 440 to be frictionally engaged within the radial clearance between peripheral wall 683 and protrusion 687. Consequently, generated vibrating forces will be able to be transmitted from oil collection vessel holder 676 to oil collection vessel 440.

Additional upward displacement of lower die assembly 653 causes corresponding vertical displacement of oil collection vessel holder 676 together with oil collection vessel 440 until lip 443 is raised above the upper surface of drawer 650, as shown in FIG. 11B. When raised, lip 443 remains at a set distance from outlet port 654 of lower die 659 to ensure that all oil extracted from the plant material will be received in oil collection vessel 440 without spilling.

Referring back to FIG. 9, extraction apparatus 400, 600 or 800 may be configured with an electronic control unit 785 that automates and/or controls at least part of the functions of the extraction apparatus. In some embodiments, such a control unit 785 provides the user with a simple user interface that facilitates production of extracts, such as cannabis extracts with no prior experience or skill.

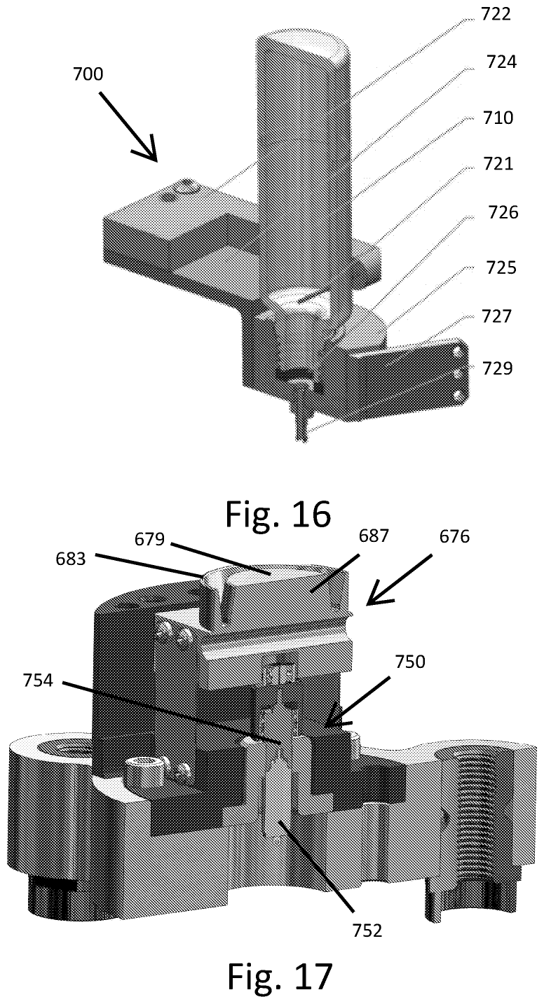

Control unit 785 may be in electrical communication with control valve 733 (FIG. 14) of the dilution system, to control when the dilution agent is added to the oil collection vessel, and with sensor 722 (FIG. 16) that indicates when container 710 is empty. For example, a controlled amount of the diluting agent may be controllably delivered to collection vessel 440 before and/or after the plant material extract has been collected.

In some embodiments of the invention, dilution of the extract reduces viscosity and increases volume, allowing for easier manipulation and dispensing of the extract.

In some embodiments, control unit 785 is in electrical communication with heating elements 674 and 678 or with gear motor 752 for controlled heating of the extracted oil for purposes of decarboxylation or other types of activation of the extract and/or mixing.

### EXAMPLE

An exemplary automatic process for operating the extraction apparatus with use of cannabis plant material and in conjunction with the control unit is as follows, one or more steps being modifiable in conjunction with other plant materials, mutatis mutandis:
a. activating the extraction apparatus;
b. preheating the upper and lower dies and the oil collection vessel holder to a temperature of 80-120° C., immediately after activating the extraction apparatus;
c. operating power train until both upper and lower dies contact capsule;
d. pressing the capsule with the heated upper and lower dies to extract oil until the 60-second period elapses;
e. separating upper die from deformed capsule and deactivating heating element of upper die;
f. raising the temperature of the oil collection vessel holder to at least 100° C. and applying this temperature for a period of 10 minutes, until the extracted oil is decarboxylated;
g. diluting and mixing extracted oil;
h. separating lower die from diluted oil and deactivating heating element of lower die; and
i. deactivating the extraction apparatus

It is expected that during the life of this patent many new uses and/or routes of administration for cannabis oil will be developed and the scope of the invention is intended to include all such new technologies a priori.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

The terms “include”, and “have” and their conjugates as used herein mean “including but not necessarily limited to”.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1-22. (canceled)

23. An apparatus for forming a cake of compressed plant material, said apparatus comprising:
a) a bottom die having a cylindrical upper portion, an inverted conical lower portion and a post extending vertically upwardly from a small-diameter region of said lower portion, wherein plant material is introducible into a cavity of said bottom die surrounding said post;
b) a top die designed and configured to conform to said cylindrical upper portion and said post and having an inverted conical lower portion with a narrower diameter than a corresponding portion in the bottom die; and
c) a power train operable to drive said top die into said bottom die so as to be in pressing relation with the plant material interposed between said top and bottom dies for a sufficient duration to produce a cake of compressed plant material.

24. The apparatus according to claim 23, further comprising:
guide rails aligning said top die with said bottom die;
one or more connectors attaching said top die to said guide rails.

25. The apparatus according to claim 24, further comprising:
a base attaching said bottom die to said guide rails.

26. An article of manufacture comprising:
a) a round member made of compressed and coalesced plant material having a circumferential portion and a central hole; and
b) a reinforceable capsule made of deformable material which is configured with an inner surface and an outer surface to define a cavity therebetween within which said round member is receivable, such that said inner and outer surfaces collectively embrace the circumferential portion of said round member while remaining unattached at a lower region thereof to facilitate discharge of oil extractable from the plant material across said lower region.

27. The article of manufacture according to claim 26 wherein the round member has a shape of a truncated cone.

28. The article of manufacture according to claim 26, wherein the inner and outer surfaces are configured as truncated cones having each an upper large-diameter region and a lower small-diameter region, such that the inner truncated cone of the capsule is seated in the outer truncated cone to form the cavity within which the round member is receivable.

29. The article of manufacture according to claim 28, wherein the inner and outer cones of the capsule are each configured with an annular lip extending radially outwardly from the upper large-diameter region and arranged such that the lip of the inner cone is engaged with the lip of the outer cone.

30. The article of manufacture according to claim 28, further comprising:
a removable seal covering a space between apical ends of said truncated cones.

31. The article of manufacture according to claim 26, provided in an external wrapper.

32. An apparatus for extracting oil from plant material, comprising:
a) a capsule comprising a compressed cake of plant material;
b) a lower die sized and configured to hold said capsule;
c) an upper die; and
d) a power train configured to drive said upper die into said lower die so as to be in pressing relation with said capsule between said upper and lower dies for a sufficient duration to cause deformation of said capsule and to apply sufficient force onto said plant material that initiates oil extraction,
wherein said extracted oil is discharged to a single discharge port.

33. The apparatus according to claim 31, further comprising a heating element in the upper die or in the lower die, or in both the upper die and lower die.

34. The apparatus according to claim 31, further comprising a control unit for controllably activating at least one of the heating elements.

35. The apparatus according to claim 31, wherein the capsule is configured with a closed cavity within which the cake of plant material is retained with the exception of a single unattached capsule region through which the extracted oil is discharged to the single discharge port.

36. The apparatus according to claim 31, wherein the capsule is releasably held by a retractable drawer.

37. The apparatus according to claim 35, wherein the power train is synchronized to cause the lower die to push the capsule upwardly before the capsule is pressed by the upper die.

38. The apparatus according to claim 31, further comprising reinforcing apparatus for sufficiently reinforcing at least a portion of the capsule when being deformed to prevent rupturing of the capsule.

39. The apparatus according to claim 34, further comprising an oil collection vessel positioned below the single discharge port and below the single unattached capsule region, said oil collection vessel is releasably supported by a retractable drawer.

40. An oil extracting process, comprising the steps of producing a cake of compressed plant material configured with a central hole, securing said cake within a capsule, pressing said capsule until oil is extracted from said plant material outwardly to said central hole and is discharged to a single discharge port.

41. The process according to claim 38, further comprising the steps of:
collecting the extracted oil in a vessel and automatically diluting the collected oil with a diluent;
automatically mixing the extracted oil and the diluent.

42. An article of manufacture comprising a round member made of compressed and coalesced plant material having a circumferential portion and a central hole.
